(19) United States
(12) Patent Application Publication
(10) Pub. No.: US 2019/0011609 A1
(43) Pub. Date: Jan. 10, 2019

(54) OPTICAL ELEMENTS WITH TOROIDAL ENGAGEMENT INTERFACES AND METHOD FOR ASSEMBLING SUCH ELEMENTS

(71) Applicant: INSTITUT NATIONAL D'OPTIQUE, Quebec (CA)

(72) Inventor: Frédéric LAMONTAGNE, Québec (CA)

(21) Appl. No.: 16/019,237

(22) Filed: Jun. 26, 2018

Related U.S. Application Data
(60) Provisional application No. 62/528,676, filed on Jul. 5, 2017.

(51) Int. Cl. G02B 3/00; G02B 3/04; B29D 11/00

(52) U.S. Cl. CPC G02B 3/0075; G02B 3/0031; B29D 11/00403; G02B 3/04; B29D 11/00019; G02B 3/0062

(57) ABSTRACT

Optical assemblies include optical elements aligned through the engagement of toroidal protrusions and toroidal grooves. A plurality of optical elements each having an inner portion having and a surrounding outer portion form a stack. Pairs of contiguous optical elements along the stack engage each other at an engagement interface including a toroidal protrusion on the outer portion of one optical element and a toroidal groove on the outer portion of the other optical element. The toroidal protrusions and groove have a symmetry of revolution about an optical axis of the inner portion of the corresponding optical element, with toroidal protrusions and toroidal grooves engaging each other having a same radius of revolution. Similar toroidal engagement of an optical element is with an annular support.

This application claims benefit of U.S. Patent Application Ser. No. 62/528,676, filed on 5 Jul. 2017 and which application is incorporated herein by reference. To the extent appropriate, a claim of priority is made to the above disclosed application.

### TECHNICAL FIELD

The technical field generally relates to the assembly and the alignment of optical elements and more particularly concerns the use of toroidal protrusions and grooves at the engagement interfaces between lenses or other optical elements.

### BACKGROUND

The use of injection molding techniques to fabricate optical elements, such as, for example, plastic lenses, offers further possibilities for designs facilitating the mounting and alignment of the resulting optical elements when compared to lenses fabricated using traditional grinding and polishing techniques. Plastic injection can provide complex geometries having purely mechanical functionalities molded into the lens itself. For example, lens assemblies included in miniature camera objectives for phones or other mobile devices are usually based on plastic lenses having intrinsically molded mechanical interfaces. Arrangements including a barrel receiving the lenses and a retaining ring maintaining them in alignment inside the barrel are therefore not necessary, as it is typically the case for glass lenses of larger dimensions.

There remains however a need for improvements in the alignment of optical elements.

### SUMMARY

In accordance with one aspect, there is provided an optical assembly, comprising a plurality of optical elements, each optical element comprising an inner portion having an optical axis and an outer portion surrounding the inner portion. The optical elements form a stack, the optical axes of the inner portions of the optical elements being aligned along the stack.

At least one pair of contiguous optical elements along the stack engage each other at an engagement interface, the engagement interface includes a toroidal protrusion extending along the outer portion of one of the contiguous optical elements of said pair, the toroidal protrusion having a symmetry of revolution about the optical axis of the inner portion the corresponding optical element. The engagement interface further includes a toroidal groove extending in the outer portion of the other one of the contiguous optical elements of the pair. The toroidal groove has a symmetry of revolution about the optical axis of the inner portion of the corresponding optical element. The toroidal protrusion and the toroidal groove have a same radius of revolution and engage each other.

In some implementations, each optical element is one of a lens, a baffle, an iris, a Diffractive Optical Element or a pinhole.

In some implementations, for at least one of the optical elements, the inner portion, the outer portion and any toroidal protrusion thereon or toroidal groove therein are molded as a monolithic element. The monolithic element may be made of a plastic material.

In some implementations, for at least one of said optical elements, the outer portion and the inner portion have been fabricated separately and assembled through Insert Precision Molding.

In some implementations, for at least one of said optical elements, the inner portion has a cylindrical profile.

In some implementations, for at least one of said optical elements, the outer portion is flange shaped.

In some implementations, for at least one of said optical elements, the toroidal protrusion has a truncated circular cross-section. In other variants, the toroidal protrusion may have a curved non-circular cross-section.

In some implementations, for at least one of said optical elements, the toroidal groove has a V-shaped cross-section. In other variants, the toroidal groove may have a curve-shaped cross-section.

In some implementations, the optical assembly is provided in combination with an annular support having a support surface engaging the bottommost optical element of said stack. In some implementations, the support surface of the annular support comprises one of a toroidal protrusion or a toroidal groove engaging a matching toroidal groove or toroidal protrusion provided underneath a bottom surface of the outer portion of the bottommost optical element of said stack.

In accordance with another aspect, there is provided an optical assembly comprising an optical element having an inner portion having an optical axis and an outer portion surrounding the inner portion, and an annular support having a support surface engaging the optical element at an engagement interface. The engagement interface includes a toroidal protrusion and a toroidal groove engaging each other. The toroidal protrusion and the toroidal groove each extends on a corresponding one of the outer portion of the optical element and the support surface of the annular support. The toroidal protrusion and the toroidal groove each have a symmetry of revolution about the optical axis of the inner portion of the optical element and have a same radius of revolution.

In some implementations, the optical element is one of a lens, a baffle, an iris, a Diffractive Optical Element or a pinhole.

In some implementations, the inner portion and the outer portion of the optical element and the toroidal protrusion thereon or the toroidal groove therein are molded as a monolithic element. The monolithic element may be made of a plastic material.

In some implementations, the outer portion and the inner portion of the optical element have been fabricated separately and assembled through Insert Precision Molding.

In some implementations, the toroidal protrusion has a truncated circular cross-section or a curved non-circular cross-section.

In some implementations, the toroidal groove has a V-shaped cross-section or a curve-shaped cross-section.

In accordance with another aspect, there is provided an optical element, comprising an inner portion configured for light interaction and defining an optical axis, and an outer portion surrounding the inner portion. The outer portion has opposite first and second surfaces. At least one of the first and second surfaces being provided with one of a toroidal protrusion having a symmetry of revolution about the optical axis of the inner portion, and a toroidal groove having a symmetry of revolution about the optical axis of the inner portion.

In some implementations, the first surface is provided with the toroidal protrusion or the toroidal groove and the second surface is free of any toroidal protrusion or toroidal groove.

In some implementations, the first surface is provided with the toroidal protrusion and the second surface is provided with the toroidal groove.

In some implementations, the first and the second surfaces are both provided with a corresponding toroidal protrusion or a corresponding toroidal groove.

In some implementations, the inner portion and the outer portion are molded as a monolithic element, for example made of a plastic material.

In some implementations, the outer portion and the inner portion have been fabricated separately and assembled through Insert Precision Molding.

In some implementations, the toroidal protrusion has a truncated circular cross-section or a curved non-circular cross-section, and the toroidal groove has a V-shaped cross-section or a curve-shaped cross-section.

In accordance with another aspect, there is provided a method of making an optical assembly, comprising:
a. providing a plurality of optical elements each comprising an inner portion having an optical axis and an outer portion surrounding the inner portion, the outer portion having opposite first and second surfaces, at least one of the first and second surfaces being provided with one of a toroidal protrusion or a toroidal groove having a symmetry of revolution about the optical axis of the inner portion; and
b. stacking the optical elements with their optical axes aligned, contiguous optical elements along said stack engaging each other at an engagement interface comprising one of said toroidal protrusions and one of said toroidal grooves engaging each other, the toroidal protrusion and toroidal groove of each of said engagement interfaces having a same radius of revolution.

In some implementations, each optical element is one of a lens, a baffle, an iris, a Diffractive Optical Element or a pinhole.

In some implementations, for at least one of said optical elements, the inner portion, the outer portion and any toroidal protrusion thereon or toroidal groove therein are molded as a monolithic element. The monolithic element may be made of a plastic material.

In some implementations, for at least one of said optical elements, the outer portion and the inner portion have been fabricated separately and assembled through Insert Precision Molding.

In some implementations, for at least one of said optical elements, the inner portion has a cylindrical profile.

In some implementations, for at least one of said optical elements, the outer portion is flange shaped.

In some implementations, for at least one of said optical elements, the toroidal protrusion has a truncated circular cross-section.

In some implementations, for at least one of said optical elements, the toroidal protrusion has a curved non-circular cross-section.

In some implementations, for at least one of said optical elements, the toroidal groove has a V-shaped cross-section.

In some implementations, for at least one of said optical elements, the toroidal groove has a curve-shaped cross-section.

In some implementations, the step of stacking the optical elements comprises mounting said stack on an annular support having a support surface engaging the bottommost optical element of said stack.

In some implementations, the support surface of the annular support comprises one of a toroidal protrusion or a toroidal groove engaging a matching toroidal groove or toroidal protrusion provided underneath a bottom surface of the outer portion of the bottommost optical element of said stack.

In accordance with a further aspect, there is provided an optical assembly comprising a plurality of optical elements, each optical element having an inner portion having an optical axis and an outer portion surrounding the inner portion.

The optical elements are stacked with their optical axes aligned. Contiguous ones of the optical elements engage each other at an engagement interface. The engagement interface includes:
a toroidal protrusion extending along the outer portion of one of the contiguous optical elements, the toroidal protrusion having a symmetry of revolution about the optical axis of the corresponding optical element; and
a toroidal groove extending in the outer portion of the other one of the contiguous optical elements, the toroidal groove having a symmetry of revolution about the optical axis of the corresponding optical element, the toroidal protrusion and the toroidal groove having a same radius of revolution and engaging each other.

In accordance with another aspect, there is also provided a method of making an optical assembly comprising a plurality of optical elements, the method comprising:
a) providing each optical element with an inner portion having an optical axis and an outer portion surrounding the inner portion;
b) providing the outer portion of each optical element with at least one of a toroidal protrusion and a toroidal groove having a symmetry of revolution about the optical axis; and
c) stacking the optical elements with their optical axes aligned and the toroidal protrusion and toroidal groove of contiguous ones of the optical elements engaging each other and defining an engagement interface, the toroidal protrusion and the toroidal groove at each engagement interface having a same radius of revolution.

Other features and advantages of the invention will be better understood upon a reading of embodiments thereof with reference to the appended drawings.

### BRIEF DESCRIPTION OF THE DRAWINGS

FIG. 1 is a cross-sectional schematic side view of a stack of lenses mounted and aligned according to one embodiment; FIG. 1A is an enlarged view of an engagement interface of the stack of FIG. 1.

FIG. 2A is a side elevation view from the top surface of an optical element according to one embodiment; FIG. 2B is a side elevation view from the bottom surface, FIG. 2C is a side elevation cross-sectional view and FIG. 2D is a cross-sectional side view of the optical element of FIG. 2A.

FIG. 3A is an exploded view of a stack of optical elements according to one embodiment; FIG. 3B is a cross-sectional side view of the stack of FIG. 3A.

FIG. 4 is a cross-sectional side view of a stack of optical elements according to another embodiment.

FIGS. 5A and 5B illustrate statistical distributions of the decentering of lenses aligned according to prior art (FIG. 5A) and according to an embodiment (FIG. 5B).

FIGS. 6A and 6B schematically illustrate the alignment of optical elements having a toroidal protrusion and groove as explained herein with manufacturing error on the radii of revolution of the engagement interface when unconstrained (FIG. 6A) and constrained (FIG. 6B).

FIGS. 7A and 7B are a side elevation view and a cross-sectional side elevation view of a cylindrical lens provided with a toroidal protrusion and a toroidal groove according to one embodiment.

FIG. 8 is a cross-sectional schematic side view of an optical assembly including a support surface and a stack of lenses according to one variant.

FIG. 9 is a cross-sectional schematic side view of an optical assembly including a support surface and a single lens according to another variant.

### DETAILED DESCRIPTION

The present description relates to optical assemblies including stacked optical elements.

It will be readily understood that the optical elements of such optical assemblies may act on incident light in various ways, for example to direct or change the direction of a light beam, focus, expand, collimate, filter, or otherwise transform or affect light. In some embodiments, at least some of the optical elements of the optical assemblies described herein are made of plastic or any other suitable material. Advantageously, the optical elements may be fabricated through conventional molding techniques according to a predetermined shape and profile providing both optical and mechanical properties.

Alternatively, at least some of the optical elements may be fabricated through other techniques such as for example using the «Insert Precision Glass Molding» (IPGM) technique, through which an insert provided with a suitable mechanical interface may be assembled with a glass or plastic lens during fabrication (see for example A. Symmons and B. Auz, “Design Considerations and Manufacturing Limitations of Insert Precision Glass Molding (IPGM)”, Proc. of the SPIE vol. 8489, 84890H, (2012)).

The optical elements may be embodied by molded lenses. Examples of lens types which may embody at least some of the optical elements include plano-convex, biconvex, plano-concave, biconcave, and positive or negative meniscus lenses. Cemented doublet or triplet lenses of the types listed above can also be considered. Some of the optical elements may also be embodied by diffractive lenses, mirrors, baffles, irises, diffractive optical elements (DOEs), pinholes, or the like. The optical elements may have spherical or aspherical surfaces and may have an off-axis profile.—It will be readily understood that the optical elements that form a given optical assembly may be of different types without departing from the scope of the present invention.

Examples of applications of the present optical assemblies include miniature lenses provided in camera objectives for phones or other mobile devices. In other examples, such optical assemblies may be used for imaging, scanning, light detection or general illumination. In some variants, optical assemblies such as presented herein may be used in medical diagnosis and treatment devices, vision and inspection, displays and videoconferencing, barcode scanning, identification and security, etc.

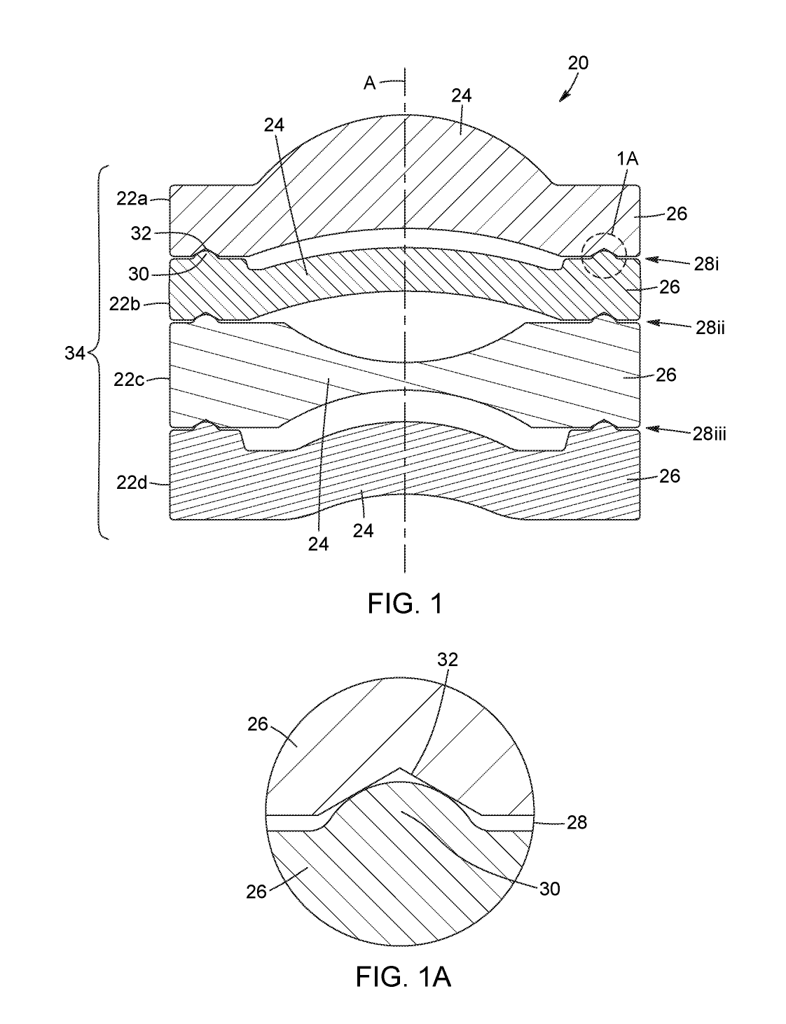

Referring to FIG. 1, there is shown an optical assembly 20 according to one embodiment. The optical assembly 20 includes a plurality of optical elements 22 forming a stack 34. Even though four optical elements 22 are shown in the variant of FIG. 1, it will be understood that the number of optical elements 22 may vary according to the optical design selected for the target application, and that reference to a “plurality” should be understood as meaning a minimum of two optical elements.

In the illustrated example of FIG. 1, the optical elements of the optical assembly 20 are shown as, respectively and from top to bottom, a meniscus first lens 22a, a meniscus second lens 22b, a biconcave third lens 22c and a meniscus fourth lens 22d. It will be readily understood that this arrangement is shown by way of example only. It will be further understood that the stacking in a vertical manner of the illustrated optical elements is not meant to impart a preferential orientation of use for the resulting optical assembly, and that the use of the expressions “top” and “bottom” in the present description is for ease of reference to the drawings only. Each optical element 22 has an inner portion 24 having an optical axis A, and an outer portion 26 surrounding the inner portion 24. Both surfaces of the inner portion 24 are designed and shaped in accordance with the desired optical properties of the optical element 22. The inner portion 24 is configured for light interaction, that is, is intended to interact with light impinging on the optical element 22 and provide the target functionalities of this optical element 22. The outer portion 26 provides structure for engagement features allowing the precision alignment of the optical element 22, as will be described in more details below. The outer portion 26 may be flange shaped, and for example form a rim around the inner portion 24. In other variants, the outer portion 26 may be tube shaped. Preferably, such as in the context of molded plastic lenses, the inner and outer portions 24 and 26 are integral to each other, that is, they are molded as a monolithic element made of plastic or other suitable material. In other implementations, the inner and outer portions 24 and 26 may be fabricated separately and then assembled using a suitable technique, such as an Insert Precision Molding technique. For example, in one variant the IPGM approach mentioned above may be used if the material forming the inner portion is glass, although other materials such as plastic may be used. One advantage of the separate fabrication of the inner and outer portion is that the outer portion may then be made of a material chosen for its mechanical properties only, regardless of the optical function of the optical element, which is provided by the inner portion. The outer portion of this portion may for example be made of a metal, for example Aluminum, Stainless Steel, Invar, Kovar, Titanium, Brass, Inconel, or the like.

The optical elements 22 of the optical assembly 20 are stacked with their respective optical axes A mutually aligned along the stack 34, as shown in FIG. 1. The various optical elements 22a, 22b, 22c and 22d are contiguous and engage each other at engagement interfaces 28. In the example of FIG. 1, therefore, the engagement interfaces 28i, 28ii and 28iii are respectively provided between the first and second lenses 22a and 22b, between the second and third lenses 22b and 22c, and between the third and fourth lenses 22c and 22d. Contiguous optical elements are in direct contact along the corresponding engagement interface 28, as explained below, and it will be readily understood that in typical embodiments the respective inner portions 24 of adjacent or contiguous optical elements 22 are spaced from each other, as shown in FIG. 1.

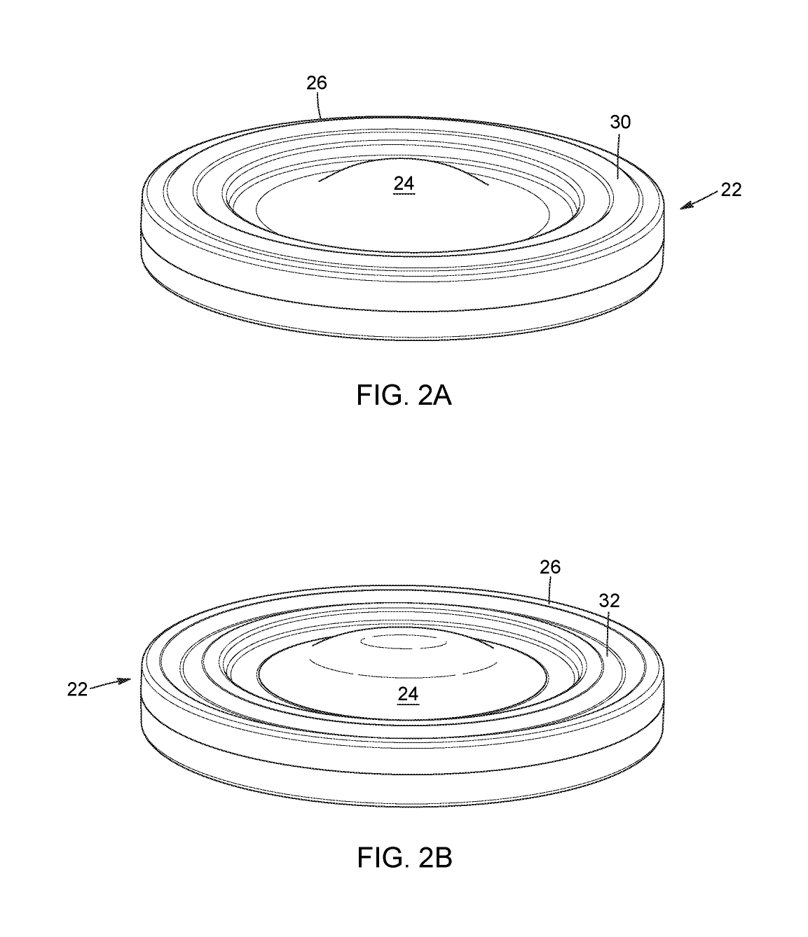

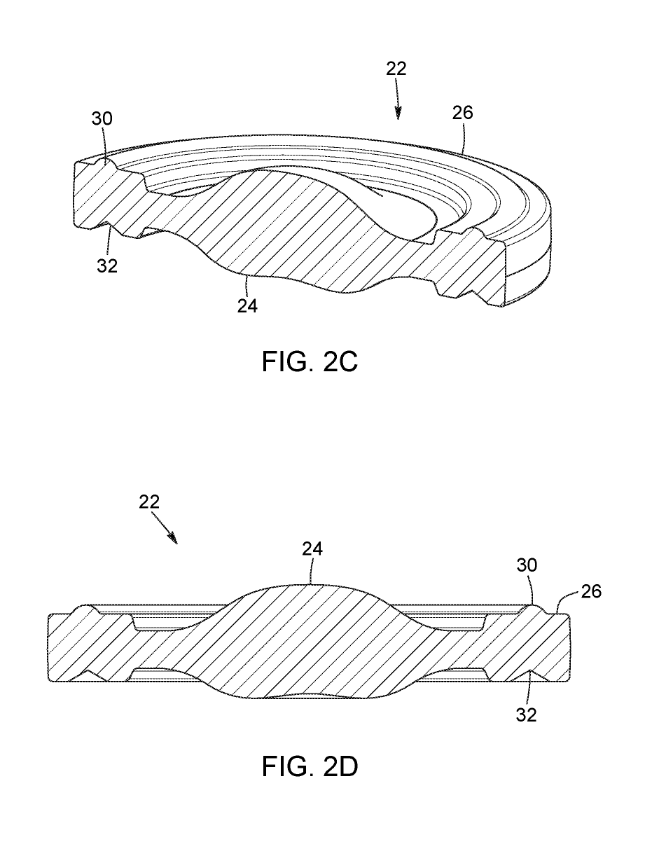

Still referring to FIG. 1 and with additional reference to FIGS. 2A to 2D, the engagement interface 28i provided between contiguous optical elements 22a and 22b will now be described. The engagement interfaces 28ii and 28iii provided between other optical elements are understood to have similar characteristics.

The engagement interface 28i includes a toroidal protrusion 30 extending along the outer portion 26 of one of the two contiguous optical elements 22a and 22b. By way of example, for the present engagement interface 28i the toroidal protrusion extends on the top surface of the outer portion 26 of the second lens 22b. The toroidal protrusion 30 has a symmetry of revolution about the optical axis A of the corresponding optical element 22b which, incidentally, coincides with the optical axes of the other optical elements 22a, 22c and 22d and defines the center axis of symmetry of the stack 34.

Mathematically, a toroid is understood as a surface of revolution about a center axis, here the optical axis A, where the surface does not intersect the center axis. As is well understood by those skilled in the art, the expression “surface of revolution” is commonly used in mathematics to designate a surface in the Euclidean space which corresponds to the rotation of a curve, referred to as the generatrix, around an axis of rotation. Despite its connotation to movement, this expression refers to a static surface and is not associated with the physical rotation of an object. A “donut” shape is an example of a toroid where the generatrix curve is a full circle, the resulting solid being called a torus in mathematical terminology. It will be readily understood that in the context of the present description, the reference to toroidal elements is not meant to be limited to torus shapes and may designate structures generated from generatrix curves other than circular.

The engagement interface 28i further includes a toroidal groove 32 extending in the outer portion 26 of the other one of the two optical elements, in this case the bottom surface of the first optical element 22a. The toroidal groove 32 also has a symmetry of revolution about the optical axis A.

The toroidal protrusion 30 and the toroidal groove 32 have a same radius of revolution. The radius of revolution may be understood as the distance between the optical axis A and the center of the shape defining the surface of revolution of the toroidal protrusion 30 and of the toroidal groove 32. The toroidal protrusion 30 and the toroidal groove 32 engage each other, that is, the toroidal protrusion 30 is inserted in the toroidal groove 32 and their respective walls are in contact with each other.

The radii of revolution of engaging toroidal protrusions and toroidal grooves may be considered the same if they have a same nominal value. The nominal value of the radius of revolution refers to its theoretically value, or the target manufacturing value specified on the manufacturing drawing of the corresponding optical element. As is known in the art, nominal dimensions can be used to describes the theoretically exact size, profile, orientation or location of a feature, and can be provided on data sheets or other documentation associated with the optical elements.

The radii of revolution of engaging toroidal protrusions and toroidal grooves may additionally or alternatively be considered the same if their exact measured values fall within the tolerance range of the same nominal value. By way of example, engaging toroidal protrusions and groove having a nominal diameter value of 3 mm and a precision tolerance of +/−0.05 mm could have slightly different measured radii of revolution both falling within the range of 2.95 mm to 3.05 mm while still being considered “the same” by one skilled in the art. In some implementations, the radii of revolution of each pair of engaging toroidal protrusion and groove are the same within a tolerance range of +/−0.02 mm. In some implementations, the radii of revolution of each pair of engaging toroidal protrusion and groove are the same within a tolerance range of +/−0.1 mm.

In the illustrated embodiment, the toroidal protrusion 30 corresponds to a section of a torus cut along a radial plane, such that the curve of revolution is a portion of a circle, for example a half circle. It can also be said that the toroidal protrusion has a truncated circular cross-section, in the sense that this cross-section corresponds to a portion of a full circle. The toroidal groove of this embodiment has a V-shaped cross-section, that is, the generatrix curve of the surface of revolution is a V shape. The V-shaped toroidal groove can also be called a “V-groove”. In some implementations, the toroidal groove may have a flat or rounded bottom section instead of a pointed through, as best illustrated in FIG. 2D.

It will be readily understood that in other embodiments the toroidal protrusion 30 and the toroidal groove 32 may have cross-sectional shapes differing from the one discussed above or illustrated in the figures without departing from the scope of the present description. By way of example, the toroidal protrusion 30 may be a surface of revolution based on an ovoid or other curved non-circular generatrix. Preferably, the toroidal protrusion 30 has rounded edges where it engages the toroidal groove 32, although in some variants it may nonetheless define sharp edges. Also by way of example, the walls of the toroidal groove 32 may be straight as in the V-groove embodiment described herein, or define a curved surface in other variants, thereby having a curved-shaped cross-section.

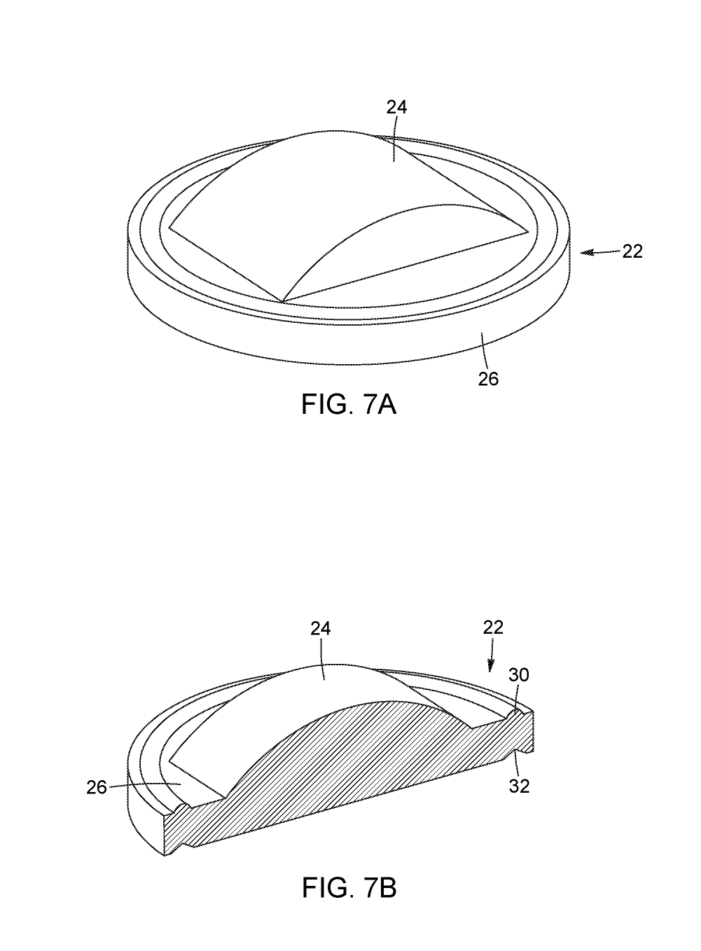

Referring to FIGS. 7A and 7B, in some embodiments the inner portion 24 of the optical element 22 may lack symmetry of revolution. In the illustrated example, the inner portion has a cylindrical profile as typically found in cylindrical lenses. Advantageously, a cylindrical shape or other non-circular geometries may be molded integrally with an outer portion 26 provided with toroidal protrusions and grooves such as explained above.

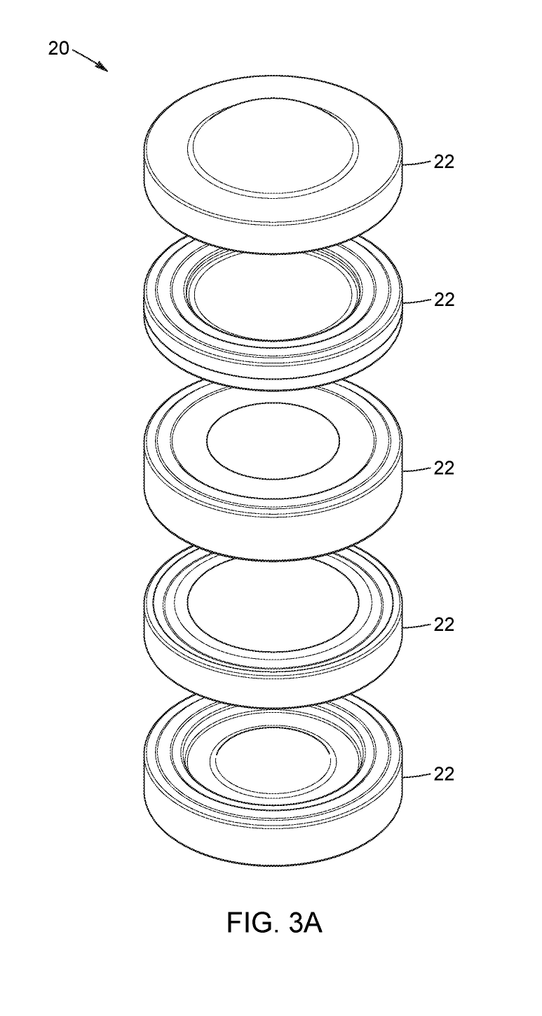

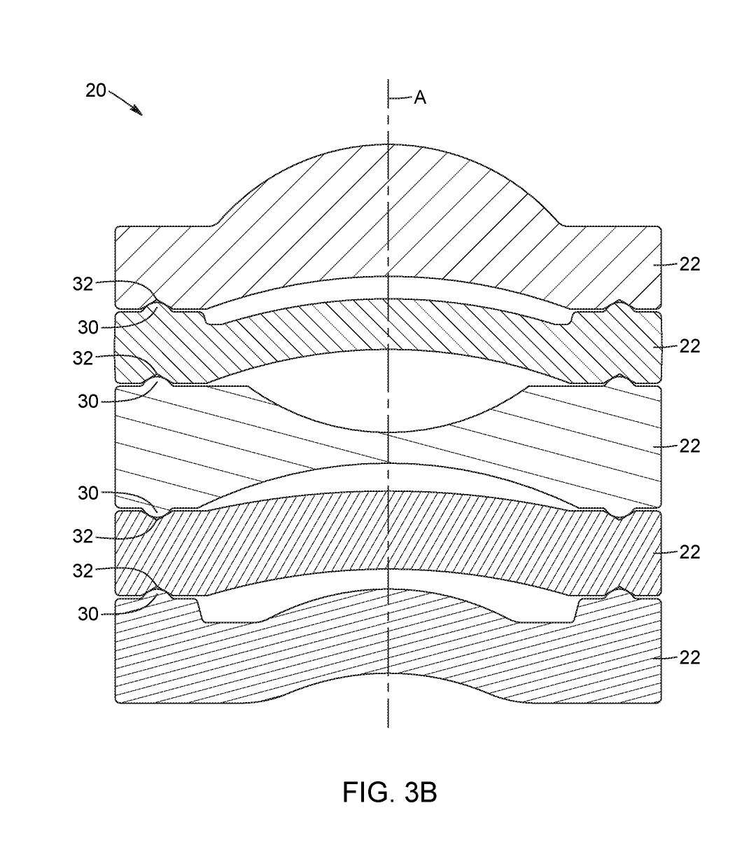

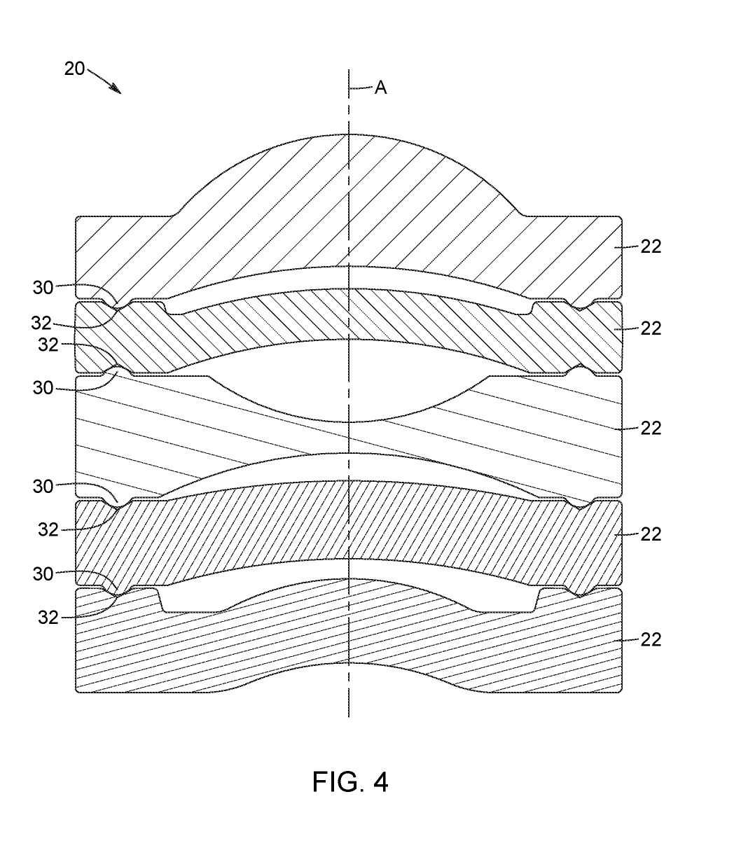

FIGS. 2A to 2D illustrate an exemplary optical element 22 having a toroidal protrusion 30 projecting from the top surface of the outer portion 26 and a toroidal groove 32 extending into the bottom surface of the outer portion 26. Such an optical element could therefore be stacked under another optical element having a toroidal groove underneath, over another optical element having a toroidal protrusion on top, or both. It will however be readily understood that other combinations of protrusions and grooves may be provided on the optical element. Referring to FIGS. 3A, 3B and 4, various combinations of protrusions and grooves in a stack are shown. It is seen that a given optical element may be provided with a toroidal protrusion on a first surface (top or bottom) and no engagement structure on the second surface, or conversely with only a toroidal groove on one of the first and second surfaces. Other optical elements may include grooves on both surfaces, protrusions on both surfaces, or a mix of the two.

In some implementations, optical elements having suitable combinations of protrusions and grooves such as explained above may be provided unassembled for later assembly, for example as single component or jointly as a kit for integration into an optical assembly. Each optical element may be configured to have:
a first surface provided with a toroidal protrusion and the second surface free of any toroidal protrusion or toroidal groove;
a first surface provided with a toroidal groove and the second surface free of any toroidal protrusion or toroidal groove;
a first surface provided with a toroidal protrusion and the second surface provided with a toroidal groove;
a first and a second surface both provided with a corresponding toroidal protrusion; or
a first and a second surface both provided with a corresponding toroidal groove.

It will be readily understood that the references to first and second surfaces in this context are made for differentiation purposes only and are not meant to connotes a preferred orientation of theses surface within an optical assembly.

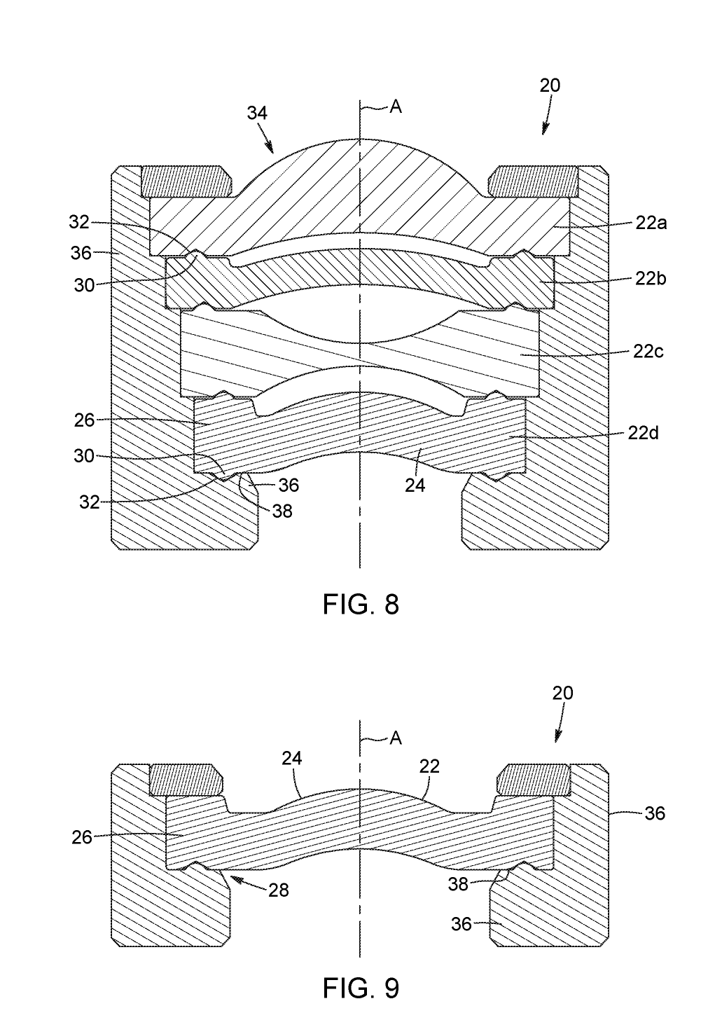

Referring to FIG. 8, in some implementations the optical assembly 20 may include or be combine with an annular support 36 having a support surface 38. In variants involving a plurality of optical elements 22a to 22d such as described above, the support surface 38 engages the bottommost optical element 22d of the stack 34. The support surface 38 may include one of a toroidal protrusion 30 or a toroidal groove 32, which engages a matching toroidal groove 32 or toroidal protrusion 30 provided underneath a bottom surface of the outer portion of the bottommost optical element 22d of the stack 34. In the illustrated variant of FIG. 8, the toroidal groove 32 is positioned within the support surface 38 whereas the toroidal protrusion 30 in on the bottommost optical element 22d. It will be readily understood that in other variants the reverse configuration may be used, that is a toroidal protrusion on the support surface and a toroidal groove in the bottommost optical element.

The annular support 36 may be embodied by any structure apt to engage the outer portion 26 of the bottommost optical element 22d while providing a light path for light transmitted and/or directed by its inner portion 24. In some embodiments the annular support may be embodied by a ledge, flange, projection, shoulder or other types of structure providing the desired support. The annular support may be integral to a barrel or other structure typically receiving a stack of lenses in an aligned relationship. In some variants, the annular support is continuous around the bottommost optical elements, whereas in other variants it may includes gaps along its periphery.

The example of FIG. 8 shows a stack 34 of optical elements 22 engaging an annular support 36. Referring to FIG. 9, there is shown an optical assembly 20 having a single optical element 22 combined with an annular support 36. The optical element 22 has an inner portion 24 having an optical axis A and an outer portion 26 surrounding the inner portion 24 and may for example be a lens of any type, a baffle, an iris, a Diffractive Optical Element or a pinhole. The annular support 36 has a support surface 38 engaging the optical element 22 at an engagement interface 28 Similarly to the embodiment described above, the engagement interface 28 includes a toroidal protrusion 30 and a toroidal groove 32 engaging each other, each extending along a corresponding one of the outer portion 26 of the optical element 22 and the support surface 38 of the annular support 36. In other words, the toroidal protrusion 30 may be provided on the annular support 36 and the toroidal groove 32 in the optical element 22, as shown in FIG. 9, or vice versa. The toroidal protrusion 30 and the toroidal groove 32 each have a symmetry of revolution about the optical axis A of the inner portion 24 of the optical element 22 and having a same (nominal) radius of revolution. All of the other features described above with respect to a stack of optical elements may also be applied to the embodiment of FIG. 9.

It will be readily understood that the optical assembly may be mounted or otherwise provided in a housing, a barrel or in other structure, depending on the intended context of use of the assembly and the requirements to be met. In some embodiments, the annular support of the embodiments of FIG. 8 or 9 may be integral to such a structure. It will be further understood that the optical elements of the assembly may be affixed together and/or to surrounding structures using techniques known in the art, such as adhesives, retaining rings or other mechanical fasteners, etc.

In accordance with another aspect, there is provided a method of making optical assemblies comprising a plurality of optical elements.

The method includes providing a plurality of optical elements each having an inner portion having an optical axis and an outer portion surrounding the inner portion, the outer portion having opposite first and second surfaces, at least one of the first and second surfaces being provided with one of a toroidal protrusion or a toroidal groove having a symmetry of revolution about the optical axis of the inner portion. This may be done in a single molding step as explained above, using the agility of molding techniques to shape the optical element according to desired structural and optical properties to provide both mechanical and optical functionalities. The manufacturing of the optical elements may also involve Insert Precision molding techniques such as the aforementioned IPGM technique, or the like.

The method further involves stacking the optical elements with their optical axes aligned and the toroidal protrusion and toroidal groove of contiguous ones of the optical elements engaging each other and defining an engagement interface. The toroidal protrusion and the toroidal groove at each engagement interface having a same radius of revolution, as explained above. It will be readily understood that the opposite surfaces of the outer portion of each optical element may be provided with various combinations of toroidal protrusions and grooves in accordance with the desired configuration of the stack, so that each engagement interface between contiguous optical element has matching protrusion and groove. The radii of revolution of the toroidal protrusions and grooves located at different interfaces may be different. However, for ease of manufacturing, in one implementation all the protrusions and grooves of the optical assembly may have the same radius of revolution.

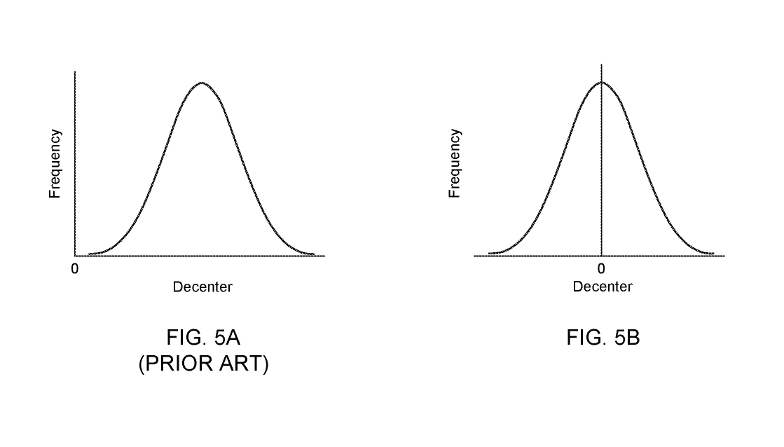

Advantageously, embodiments of the engagement interface described above may provide a better mounting precision than prior art techniques since the nominal configuration (i.e. excluding fabrication errors) results in a theoretically perfect alignment. Indeed, in prior art approaches, such as for example the securing of lenses in barrels using retaining rings, a minimal clearance or play between the lenses and other components is required so that the lenses can be assembled without mechanical interference. Typically, the present approach reduces the statistical centering error by a factor of 2 for a same manufacturing tolerance range, as the manufacturing tolerance can be assigned on either side of the nominal value, as illustrated in FIG. 5B. This is to be contrasted with the manufacturing tolerance considered for mounting lenses having an amount of radial play, such as shown in FIG. 5A (PRIOR ART), where the manufacturing tolerance must be assigned in a single direction to avoid mechanical interference which could prevent the assembly of the lenses.

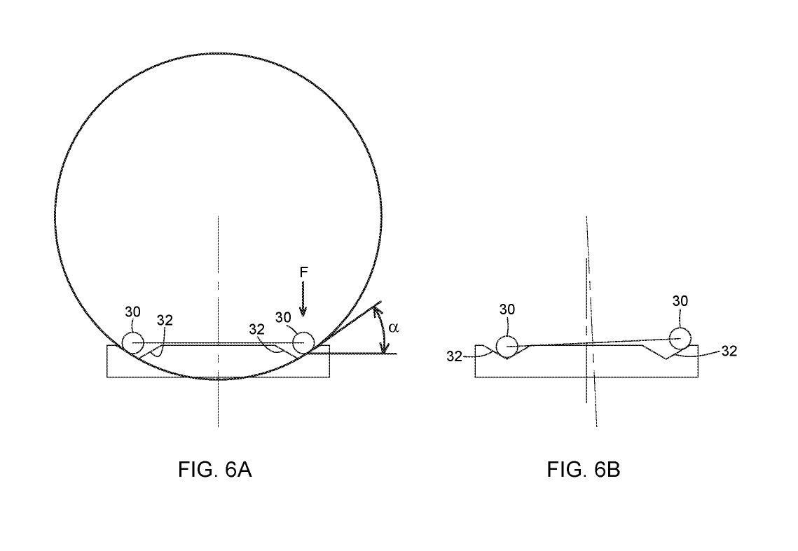

The impact of the manufacturing tolerance on the centering of the lenses using the approach described herein was studied in detail. A particularity of engagement interfaces such as described above is that a mismatch of the radii of the toroidal protrusion and of the toroidal groove results in a tilt error in the relative position of the assembled lenses, in addition to a centering error. However, the tilt error is of the same order as the centering error, unlike traditional centering methods where a small tilt is typically associated with a larger decentering. This can be visualized on FIGS. 6A and 6B. On FIG. 6A, a slight mismatch of the diameters of the two toroidal structures leads to a centered position in which the toroidal protrusion is not completely constrained within the toroidal groove. To be in a stable equilibrium, the toroidal protrusion would tend to slide within the groove on one side, such as shown in FIG. 6B, so that at the extreme position of tilt there are three points of contact between the protrusion and the groove. This rocking movement of the toroidal protrusion in the toroidal groove results in a centering and a tilt error between the two optical elements. It will be noted that for this movement to take place, the angle of contact a (shown in FIG. 6A) between the toroidal protrusion 30 and groove 32 should be large enough so that friction forces between these two components are overcome when an axial force F is applied on the assembly. When this condition is met, the optical element is allowed to reach the stable equilibrium position where it is fully constrained at the three points of contact between the toroidal protrusion and the toroidal groove when an axial force, such as gravity acceleration or a clamping force, is applied on the stack. If the toroidal protrusion cannot slide in the toroidal groove because of an insufficient contact angle, the lens may not be set properly, and the centering function of the invention may not be achieved. As for typical inclined plane free body diagram, it can be found that this condition is fulfill if the coefficient of friction is smaller than the tangent of the angle α, that is, μ<tan(α).

In summary, optical assemblies as described herein may be assembled with improved performances when compared to more traditional assemblies involving a radial play between the components. It has been found that the present approach can cut by a factor of 2 the statistical decentering of optical elements compared to prior art methods, which opens the door at obtaining equivalent optical performances at lower cost. Advantageously, the mutual alignment of the optical elements does not require specialty tools.

Of course, numerous modifications could be made to the embodiments above without departing from the scope of the invention.

1. An optical assembly, comprising:
a plurality of optical elements, each optical element comprising an inner portion having an optical axis and an outer portion surrounding the inner portion, said optical elements forming a stack, the optical axes of the inner portions of said optical elements being aligned along said stack, at least one pair of contiguous optical elements along said stack engaging each other at an engagement interface, the engagement interface comprising:
a toroidal protrusion extending along the outer portion of one of the contiguous optical elements of said pair, the toroidal protrusion having a symmetry of revolution about the optical axis of the inner portion of the corresponding optical element; and
a toroidal groove extending in the outer portion of the other one of the contiguous optical elements of said pair, the toroidal groove having a symmetry of revolution about the optical axis of the inner portion of the corresponding optical element;
wherein the toroidal protrusion and the toroidal groove have a same radius of revolution and engage each other.

2. The optical assembly according to claim 1, wherein each optical element is one of a lens, a baffle, an iris, a Diffractive Optical Element or a pinhole.

3. The optical assembly according to claim 1, wherein, for at least one of said optical elements, the inner portion, the outer portion and any toroidal protrusion thereon or toroidal groove therein are molded as a monolithic element.

4. The optical assembly according to claim 3, wherein said monolithic element is made of a plastic material.

5. The optical assembly according to claim 1, wherein, for at least one of said optical elements, the outer portion and the inner portion are fabricated separately and assembled through Insert Precision Molding.

6. The optical assembly according to claim 1, wherein, for at least one of said optical elements, the inner portion has a cylindrical profile.

7. The optical assembly according to claim 1, wherein, for at least one of said optical elements, the outer portion is flange shaped.

8. The optical assembly according to claim 1, wherein, for at least one of said optical elements, the toroidal protrusion has a truncated circular cross-section.

9. The optical assembly according to claim 1, wherein, for at least one of said optical elements, the toroidal protrusion has a curved non-circular cross-section.

10. The optical assembly according to claim 1, wherein, for at least one of said optical elements, the toroidal groove has a V-shaped cross-section.

11. The optical assembly according to claim 1, wherein, for at least one of said optical elements, the toroidal groove has a curve-shaped cross-section.

12. The optical assembly according to claim 1, in combination with an annular support having a support surface engaging a bottommost optical element of said stack.

13. The combination of claim 12, wherein the support surface of the annular support comprises one of a toroidal protrusion or a toroidal groove engaging a matching toroidal groove or toroidal protrusion provided underneath a bottom surface of the outer portion of the bottommost optical element of said stack.

14. An optical assembly, comprising:
an optical element comprising an inner portion having an optical axis and an outer portion surrounding the inner portion;
an annular support having a support surface engaging the optical element at an engagement interface, the engagement interface comprising a toroidal protrusion and a toroidal groove engaging each other, the toroidal protrusion and the toroidal groove each extending on a corresponding one of the outer portion of the optical element and the support surface of the annular support, the toroidal protrusion and the toroidal groove each having a symmetry of revolution about the optical axis of the inner portion of the optical element and having a same radius of revolution.

15. The optical assembly according to claim 14, wherein the optical element is one of a lens, a baffle, an iris, a Diffractive Optical Element or a pinhole.

16. The optical assembly according to claim 14, wherein the inner portion and the outer portion of the optical element and the toroidal protrusion thereon or the toroidal groove therein are molded as a monolithic element.

17. The optical assembly according to claim 16, wherein said monolithic element is made of a plastic material.

18. The optical assembly according to claim 14, wherein the outer portion and the inner portion of the optical element are fabricated separately and assembled through Insert Precision Molding.

19. The optical assembly according to claim 14, wherein the toroidal protrusion has a truncated circular cross-section.

20. The optical assembly according to claim 14, wherein the toroidal protrusion has a curved non-circular cross-section.

21. The optical assembly according to claim 14, wherein the toroidal groove has a V-shaped cross-section.

22. The optical assembly according to claim 14, wherein the toroidal groove has a curve-shaped cross-section.

23. An optical element, comprising:
an inner portion configured for light interaction and defining an optical axis; and
an outer portion surrounding the inner portion, the outer portion having opposite first and second surfaces, at least one of the first and second surfaces being provided with one of:
a toroidal protrusion having a symmetry of revolution about the optical axis of the inner portion; and
a toroidal groove having a symmetry of revolution about the optical axis of the inner portion.

24. The optical element according to claim 23, wherein the first surface is provided with said toroidal protrusion or said toroidal groove and the second surface is free of any toroidal protrusion or toroidal groove.

25. The optical element according to claim 23, wherein the first surface is provided with said toroidal protrusion and the second surface is provided with said toroidal groove.

26. The optical element according to claim 23, wherein the first and the second surfaces are both provided with a corresponding toroidal protrusion.

27. The optical element according to claim 23, wherein the first and the second surfaces are both provided with a corresponding toroidal groove.

28. The optical element according to claim 23, wherein the inner portion and the outer portion are molded as a monolithic element.

29. The optical element according to claim 28, wherein said monolithic element is made of a plastic material.

30. The optical element according to claim 23, wherein the outer portion and the inner portion are fabricated separately and assembled through Insert Precision Molding.

31. The optical element according to claim 23, wherein the toroidal protrusion has a truncated circular cross-section.

32. The optical element according to claim 23, wherein the toroidal protrusion has a curved non-circular cross-section.

33. The optical element according to claim 23, wherein the toroidal groove has a V-shaped cross-section.

34. The optical element according to claim 23, wherein the toroidal groove has a curve-shaped cross-section.

35. A method of making an optical assembly, comprising:
a. providing a plurality of optical elements, each comprising an inner portion having an optical axis and an outer portion surrounding the inner portion, the outer portion having opposite first and second surfaces, at least one of the first and second surfaces being provided with one of a toroidal protrusion or a toroidal groove having a symmetry of revolution about the optical axis of the inner portion; and
b. stacking the optical elements with their optical axes aligned, contiguous optical elements along said stack engaging each other at an engagement interface comprising one of said toroidal protrusions and one of said toroidal grooves engaging each other, the toroidal protrusion and toroidal groove of each of said engagement interfaces having a same radius of revolution.

36. The method according to claim 35, wherein each optical element is one of a lens, a baffle, an iris, a Diffractive Optical Element or a pinhole.

37. The method according to claim 35, wherein, for at least one of said optical elements, the inner portion, the outer portion and any toroidal protrusion thereon or toroidal groove therein are molded as a monolithic element.

38. The method according to claim 37, wherein said monolithic element is made of a plastic material.

39. The method according to claim 35, wherein, for at least one of said optical elements, the outer portion and the inner portion are fabricated separately and assembled through Insert Precision Molding.

40. The method according to claim 35, wherein, for at least one of said optical elements, the inner portion has a cylindrical profile.

41. The method according to claim 35, wherein, for at least one of said optical elements, the outer portion is flange shaped.

42. The method according to claim 35, wherein, for at least one of said optical elements, the toroidal protrusion has a truncated circular cross-section.

43. The method according to claim 35, wherein, for at least one of said optical elements, the toroidal protrusion has a curved non-circular cross-section.

44. The method according to claim 35, wherein, for at least one of said optical elements, the toroidal groove has a V-shaped cross-section.

45. The method according to claim 35, wherein, for at least one of said optical elements, the toroidal groove has a curve-shaped cross-section.

46. The method according to claim 35, wherein the step of stacking the optical elements comprises mounting said stack on an annular support having a support surface engaging a bottommost optical element of said stack.

47. The method according to claim 46, wherein the support surface of the annular support comprises one of a toroidal protrusion or a toroidal groove engaging a matching toroidal groove or toroidal protrusion provided underneath a bottom surface of the outer portion of the bottommost optical element of said stack.
